(19) United States
(12) Patent Application Publication
(10) Pub. No.: US 2026/0300772 A1
(43) Pub. Date: Oct. 1, 2026

(54) RETRIEVAL-AUGMENTED GENERATION METHOD AND APPARATUS BASED ON SEMANTIC-ENHANCED KNOWLEDGE GRAPH

(71) Applicant: Hangzhou Dianzi University, Hangzhou City (CN)

(72) Inventors: Xiaoliang XU, Hangzhou City (CN); Kang YANG, Hangzhou City (CN)

(21) Appl. No.: 19/254,742

(22) Filed: Jun. 30, 2025

(30) Foreign Application Priority Data
Apr. 1, 2025 (CN) 202510398457.0

(51) Int. Cl. G06N 5/025; G06F 16/3329; G06F 16/35

(52) U.S. Cl. CPC G06N 5/025; G06F 16/33295; G06F 16/35

(57) ABSTRACT

A retrieval-augmented generation method and apparatus based on a semantic-enhanced knowledge graph are provided. The method includes constructing a semantic-enhanced knowledge graph and a retrieval strategy based on the semantic-enhanced knowledge graph, where a retrieval result includes a first context or a second context. The first context is determined according to entity information and inter-entity relational information in a subgraph, and the second context is determined according to the entity information and the inter-entity relational information in the subgraph and relevant entity information. An answer is obtained according to the first context or the second context. This method enhances detail information of entities and semantic information of knowledge graphs, thereby generating a more accurate answer. Because this method extracts specific information required for a specific entity as needed, rather than extracting specified entity information during construction of the knowledge graph, the method is universal.

### CROSS-REFERENCE TO RELATED APPLICATION

This patent application claims the benefit and priority of Chinese Patent Application No. 2025103984570 filed with the China National Intellectual Property Administration on Apr. 1, 2025, the disclosure of which is incorporated by reference herein in its entirety.

### TECHNICAL FIELD

The disclosure relates to the technical field of question-answering systems in human-computer interactive dialogues, and in particular to a retrieval-augmented generation method and apparatus based on a semantic-enhanced knowledge graph.

### BACKGROUND

Large Language Models (LLMs) have demonstrated powerful natural language understanding and human-like text generation capabilities in practical applications, but still face the problem of hallucination, i.e., generated contents are inconsistent with common sense or inconsistent with provided contents.

Retrieval-Augmented Generation (RAG) helps the LLMs obtain external knowledge by retrieving relevant information from an external text corpus, thereby improving the accuracy of responses. However, the RAG has the following limitations: (1) ignorance of relational information: textual content is not isolated but generally interconnected and inherently possesses a graph structure. Traditional RAG fails to capture relational knowledge that cannot be represented by semantic similarity. (2) redundant information: the RAG uses text chunks to represent external knowledge, which may exceed an input length limit of the LLMs or lose information.

In order to solve those problems, some studies in recent years have proposed using Knowledge Graphs (KG) as external knowledge sources. Different from traditional RAG, Graph Retrieval-Augmented Generation (Graph RAG) retrieves subgraph including relational information from the knowledge graph as context. The Graph RAG can capture the relational information between text chunks and improve reasoning capability, but still has the defects of lack of generalization capability and low answer accuracy.

### SUMMARY

An objective of the disclosure is to provide a retrieval-augmented generation method and apparatus based on a semantic-enhanced knowledge graph, which can improve the capability of generalization and the accuracy of answers.

To achieve the above objective, the disclosure provides the following solutions.

In a first aspect, the disclosure provides a retrieval-augmented generation method based on a semantic-enhanced knowledge graph.

The method starts by acquiring an original text document, A semantic-enhanced knowledge graph is constructed according to entity information and inter-entity relational information among entities extracted from the original text document, where the semantic-enhanced knowledge graph includes an entity set, an inter-entity relationship set, a relevant sentence set, and a mapping relation set, where the relevant sentence set refers to a set of sentences relevant to entities and inter-entity relationships, and the mapping relation set refers to a set of mapping relations between sentences in the original text document and target objects, where the target objects are entity nodes and relationship edges in the semantic-enhanced knowledge graph. A subgraph is obtained according to an explicit entity set and the semantic-enhanced knowledge graph; and determining, by using large language models (LLMs), whether entity information and inter-entity relational information in the subgraph are sufficient to answer a user question, to obtain a first determination result.

If the first determination result is yes, the entity information and the inter-entity relational information in the subgraph is used as a first context, and a first prompt is constructed according to the first context and the user question, and an answer corresponding to the user question is generated based on the first prompt by using the LLMs;

If the first determination result is no, relevant entity information is extracted from a hybrid relevant sentence set, using the relevant entity information and the entity information and the inter-entity relational information in the subgraph as a second context, and a second prompt is constructed according to the second context and the user question, where the hybrid relevant sentence set is a set of sentences in the subgraph relevant to hybrid entities and inter-hybrid entity relationships, and an answer corresponding to the user question is generated based on the second prompt by using the LLMs.

In a second aspect, the disclosure provides a retrieval-augmented generation apparatus based on a semantic-enhanced knowledge graph, including a document obtaining module, a semantic-enhanced knowledge graph construction module, an entity alignment and merging module, an explicit entity extraction module, a subgraph expansion module, a subgraph construction module, and a determination module.

The document obtaining module is configured to obtain an original text document.

The semantic-enhanced knowledge graph construction module is configured to construct a semantic-enhanced knowledge graph according to entity information and inter-entity relational information extracted from the original text document. The semantic-enhanced knowledge graph includes an entity set, an inter-entity relationship set, a relevant sentence set, and a mapping relation set. The relevant sentence set refers to a set of sentences relevant to entities and inter-entity relationships, and the mapping relation set refers to a set of mapping relations between sentences in the original text document and target objects. The target objects are entity nodes and relationship edges in the knowledge graph.

The subgraph construction module is configured to obtain a subgraph according to an explicit entity set and the semantic-enhanced knowledge graph.

The determination module is configured to determine, by using LLMs, whether entity information and inter-entity relational information in the subgraph are sufficient to answer a user question, to obtain a first determination result. If the first determination result is yes, the entity information and the inter-entity relational information in the subgraph are used as a first context, and a first prompt is constructed according to the first context and the user question; and based on the first prompt by using the LLMs, an answer corresponding to the user question is generated. If the first determination result is no, relevant entity information is extracted from a hybrid relevant sentence set, the relevant entity information and the entity information and the inter-entity relational information in the subgraph are used as a second context, and a second prompt is constructed according to the second context and the user question; and based on the second prompt by using the LLMs, an answer corresponding to the user question are generated. The hybrid relevant sentence set is a set of sentences in the subgraph relevant to hybrid entities and inter-hybrid entity relationships.

According to specific embodiments provided in the disclosure, the disclosure has the following technical effects:

The disclosure provides a retrieval-augmented generation method and apparatus based on a semantic-enhanced knowledge graph. The method includes constructing a semantic-enhanced knowledge graph; performing retrieval based on a retrieval strategy of the semantic-enhanced knowledge graph, where a retrieval result includes a first context or a second context, the first context is determined according to entity information and inter-entity relational information in a subgraph, and the second context is determined according to the entity information and the inter-entity relational information in the subgraph and relevant entity information; and obtaining an answer according to the first context or the second context. This method enhances detail information of entities and semantic information of knowledge graphs, thereby generating a more accurate answer. Furthermore, because this method extracts specific information (context) required for a specific entity as needed, rather than extracting specified entity information during construction of the knowledge graph, the method is universal.

### BRIEF DESCRIPTION OF THE DRAWINGS

FIG. 1 is a flow diagram of a retrieval-augmented generation method based on a semantic-enhanced knowledge graph according to Embodiment 1 of the disclosure;

FIG. 2 is a schematic diagram of the semantic-enhanced knowledge graph according to Embodiment 1 of the disclosure; and

FIG. 3 is a flowchart of a specific application example of the retrieval-augmented generation method based on the semantic-enhanced knowledge graph according to Embodiment 1 of the disclosure.

### DETAILED DESCRIPTION OF THE EMBODIMENTS

### Embodiment 1

Research found that Graph RAG methods still face the following challenges:
(1) Lack of generalization capability: Most existing Graph RAG methods are constructed based on existing knowledge graphs. However, constructing a high-quality knowledge graph requires deep expertise and significant time investment, making the process costly. In addition, before constructing a knowledge graph, it is necessary to design an architecture suitable for a specific application scenario. However, such pre-definition also limits information in the knowledge graph.
(2) Lack of details: In practical applications of Graph RAG, knowledge graphs usually only include entities and relationships thereof, but ignore specific information about the entities or evidence supporting the relationships. Compared with using text corpora as external knowledge sources, although knowledge graphs provide powerful relational information, the knowledge graphs are extremely lacking in details.

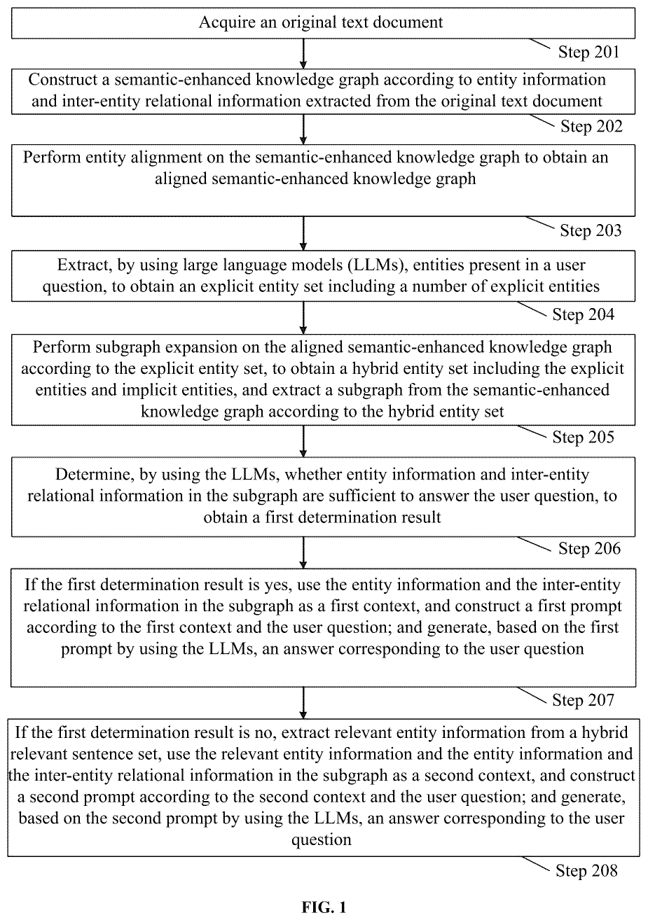

In response to the above defects, this embodiment provides a retrieval-augmented generation method based on a semantic-enhanced knowledge graph, which can improve the capability of generalization and the accuracy of answers. As shown in FIG. 1, the method includes the following step 201 to step 208.

In step 201, an original text document is obtained.

In step 202, entity information and inter-entity relational information are extracted from the original text document T, and a semantic-enhanced knowledge graph EG=(ε, v, S, M) is constructed according to the extracted entity information and inter-entity relational information, where the semantic-enhanced knowledge graph includes an entity set, an inter-entity relationship set, a relevant sentence set, and a mapping relation set. The mapping relation set refers to a set of mapping relations between sentences in the original text document and target objects, and the target objects are entity nodes and relationship edges in the knowledge graph. ε={e₁, e₂, . . . , eₙ} is the entity set. v={rₖ=(eᵢ, eⱼ)|eᵢ, eⱼ εε, i≠j} is a set of relationships among entities in the entity set ε. S={s₁, s₂, . . . , sₙ} is a set of sentences in T, which is relevant to the entities and inter-entity relationships, i.e., the relevant sentence set. M={(eᵢ, sⱼ)|eᵢ ∈ε, sⱼ ∈S}∪{(rₖ, sₗ)|rₖ∈v, sₗ∈S} is a set of mapping relations, i.e. the mapping relation set, between the sentences in the text and relevant entity nodes and relationship edges in the knowledge graph.

The process of extracting the entity information and the inter-entity relational information in step 202 (i.e., step 202-1) specifically includes step 202-1-1 to step 202-1-6.

In step 202-1-1, document segmentation is performed on the original text document T provided by a user, to obtain a set of a number of text chunks T={chunk₁, chunk₂, . . . , chunkₙ}.

In step 202-1-2, sentence segmentation is performed on the original text document T by using a language model, to obtain a sentence set S={s₁, s₂, . . . , sₙ} including a number of sentences.

In step 202-1-3, the number of tokens, denoted as Token(s), of each sentence (i.e., s E S) in the sentence set is calculated by using a tokenization model.

In step 202-1-4, consecutive sentences whose total number of tokens does not exceed a set chunk size k are grouped into a text chunk.

In step 202-1-5, a chunk set

$$T = \{ {chunk}_{p} = \{ {s}_{i} , {s}_{i + 1} , … , {s}_{j} \} \vert {\sum }_{t = i}^{j} Token ( {s}_{t} ) \leq k , 1 \leq i \leq j \leq n \}$$

is constructed according to all the chunks.

In step 202-1-6, the entity information and the inter-entity relational information are extracted from the chunk set.

In step 202, the constructing a semantic-enhanced knowledge graph according to the extracted entity information and inter-entity relational information (i.e., step 202-2) specifically includes step 202-2-1 and step 202-2-2.

In step 202-2-1, a chunk semantic-enhanced knowledge graph EGᵢ=(εᵢ, vᵢ, Sᵢ, Mᵢ) is constructed according to entity information and inter-entity relational information extracted from each chunk (i.e. chunkᵢ∈T).

In step 202-2-2, all the chunk semantic-enhanced knowledge graphs EGᵢ are merged to obtain the semantic-enhanced knowledge graph EG of the original text document T.

Step 202-2-1 specifically includes:
(1) extracting entity information and inter-entity relational information of a specified entity type from each chunk chunkᵢ by using the LLMs, where the entity information includes an entity name, an entity type, and an entity description, and the inter-entity relational information includes a source entity, a target entity, a relationship description, and a relationship basis;
(2) constructing a chunk entity set and a chunk inter-entity relationship set according to the extracted entity information and inter-entity relational information of the specified entity type, where the chunk inter-entity relationship set includes relationships among a number of entities in the chunk entity set Et, where the chunk entity set is denoted εᵢ={ε₁, e₂, . . . , eₙ}, and the chunk inter-entity relationship set is denoted vᵢ={rₖ=(eₚ, e_{q})};
(3) evaluating an information content score, denoted as Score(s), of sentences in each of the chunks;
(4) establishing, when the information content score Score(s) is not less than an information content threshold k and entities present in the sentence s belong to the chunk entity set (i.e., e∈εᵢ), mapping relations between the sentence and the entities present in the sentence (i.e., mapping s to e);
(5) constructing, according to the mapping relations between the sentences and the entities present in the sentences, a set of mapping relations Mₑ={(e, s)|e∈εᵢ, s∈chunkᵢ} between chunk text contents and the entities;
(6) establishing, when the information content score Score(s) is not less than the information content threshold p and the sentence s is derived from an inter-entity relationship in the chunk inter-entity relationship set (i.e., the sentence s is an origin of relationship r∈vᵢ), a mapping relation between the sentence and the inter-entity relationship in the chunk inter-entity relationship set (i.e., mapping the sentence s to the relation r);
(7) constructing, according to the mapping relations between the sentences and the inter-entity relationships in the chunk inter-entity relationship set, a set of mapping relations Mᵣ={(r, s)|r∈vᵢ,s∈chunkᵢ} between the chunk text contents and the inter-entity relationships;
(8) determining a chunk mapping relation set Mᵢ=Mₑ∪Mᵣ and a chunk relevant sentence set Sᵢ={s|(e, s)∈Mₑ}∪{s|(r, s)∈Mᵣ} according to the set of mapping relations between the chunk text contents and the entities and the set of mapping relations between the chunk text contents and the entities; and
(9) constructing the chunk semantic-enhanced knowledge graph EGᵢ according to the chunk entity set, the chunk inter-entity relationship set, the chunk relevant sentence set, and the chunk mapping relation set.

In step 203, entity alignment is performed on the semantic-enhanced knowledge graph EG obtained in step 202 to obtain an aligned semantic-enhanced knowledge graph, to improve the standardization and consistency of the semantic-enhanced knowledge graph.

Step 203 specifically includes step 203-1 and step 203-2.

In step 203-1, the entities in the entity set & is pre-categorized according to the entity type to obtain an entity type set E={{eᵢ|eᵢ ∈Cₖ}|k=1, 2, . . . m} including a number of entities of different types, where Cₖ represents the k^{th} category.

In step 203-2, clustering is performed on entities (ε∈E) of the same type in the entity type set based on semantic similarity, to obtain a clustered entity set.

A specific process of step 203-2 includes step 203-2-1 to step 203-2-5.

In step 203-2-1, text vectorization is performed on the entity names and the respective entity descriptions of the entities of the same type in the entity type set by using an embedding model, to obtain each entity vector, i.e., converting “<entity name>:<entity description>” into a vector form as a vector representation of e∈ε.

In step 203-2-2, a second similarity sim(v₁, v₂) is calculated according to the entity vector.

In step 203-2-3, an association edge is added to entities each whose second similarity is higher than a second similarity threshold f, and construct an inter-entity association graph g=(ε, v), where v={(eᵢ, eⱼ)|sim(eᵢ, eⱼ)>f, eᵢ, eⱼ ∈ε}.

In step 203-2-4, all connected subgraphs are extracted from the inter-entity association graph g.

In step 203-2-5, a clustered entity set is constructed according to nodes included in the connected subgraphs (nodes included in each connected subgraph are a new entity set).

In step 203-3, whether the entities in the clustered entity set are the same entity is determined using the LLMs to obtain a second determination result.

In step 203-4, if the second determination result is yes, entity nodes belonging to the same entity in the semantic-enhanced knowledge graph EG are merged.

In step 204, for a user question q, entities present in the user question are extracted by using the LLMs to obtain an explicit entity set ε_{q}={e₁, e₂, . . . , eₙ} including a number of explicit entities (i.e., entities present in q).

In step 205, subgraph expansion is performed on the semantic-enhanced knowledge graph EG according to the explicit entity set ε_{q} obtained in step 204, to obtain a hybrid entity set εₛ={e₁, e₂, . . . , eₘ} including the explicit entities and implicit entities, where n≤m. A subgraph EG_{sub}={εₛ, vₛ, Sₛ, Mₛ} is extracted from the aligned semantic-enhanced knowledge graph according to the hybrid entity set εₛ={e₁, e₂, . . . , eₘ}, where the implicit entity refers to an entity involved with the user question q but not present in the user question q.

A method for subgraph expansion includes step 205-1 to step 205-8.

In step 205-1, the explicit entities in the explicit entity set ε_{q} are added to an initial entity list E.

In step 205-2, text vectorization is performed on the user question q by using an embedding model to obtain a question vector q_{emb}, and the text is vectorized by using the embedding model, denoted as emb(s).

In step 205-3, for each explicit entity in the initial list, the semantic-enhanced knowledge graph is traversed to determine neighbor nodes, i.e., sequentially fetching e∈E, and traversing all neighbor nodes Neighbor(e)={e₁, . . . , eₙ} of e on the semantic-enhanced knowledge graph EG=(ε, v, S, M).

In step 205-4, text vectorization is performed on a neighbor relationship description by using the embedding model to obtain a neighbor relationship description vector r_{emb}=emb(r), where the neighbor relationship description refers to a description of a relationship between a neighbor node eⱼ∈Neighbor(e), eⱼ∉E not in the initial entity list E and a corresponding explicit entity e.

In step 205-5, a first similarity between the problem vector q_{emb} and the neighbor relationship description vector is calculated.

In step 205-6, if the first similarity is greater than a first similarity threshold f, the corresponding neighbor node eⱼ is added to the initial entity list E to obtain an updated entity list.

In step 205-7, the updated entity list is used as a new initial entity list, and the process returns to step 205-3 to obtain a final entity list.

In step 205-8, after the expansion is completed, according to the final entity list, a hybrid entity set including the explicit entities and the implicit entities is obtained, i.e., εₛ=E.

In step 206, by using the LLMs, whether the entity information and the inter-entity relational information in the subgraph EG_{sub} are sufficient to answer the user question q is determined to obtain a first determination result.

In step 207, if the first determination result is yes, the entity information and the inter-entity relational information in the subgraph are used as a first context; a first prompt is constructed according to the first context and the user question; and a final response r is generated based on the first prompt by using the LLMs, i.e., generating an answer corresponding to the user question.

In step 208, if the first determination result is no, LLMs are prompted to determine that other relevant entity information is required in addition to the entity information and the inter-entity relational information in the subgraph; and perform deep extraction. Specifically, relevant entity information is extracted from a hybrid relevant sentence set Sₑ={sⱼ|(e, sⱼ)∈Mₛ}. The relevant entity information and the entity information and the inter-entity relational information in the subgraph are used as a second context, a second prompt is constructed according to the second context and the user question, and a final response r is generated based on the second prompt by using LLMs, i.e., generating an answer corresponding to the user question, where the hybrid relevant sentence set is a set of sentences in the subgraph relevant to hybrid entities and inter-hybrid entity relationships.

The extracting relevant entity information from a hybrid relevant sentence set (for required entity information m, retrieving relevant sentences from the hybrid relevant sentence set Sₑ={s|(e, s)∈M}) specifically includes:
(1) performing text vectorization on the required entity information m and each sentence in the hybrid relevant sentence set Se by using the embedding model, to obtain a required entity information vector m_{emb}=emb(m) and a sentence vector S_{emb}={s_{emb}=emb(s)|s∈Sₑ}, where the required entity information refers to entity information in the subgraph for which the first determination result is no;
(2) calculating a semantic similarity between the required entity vector m_{emb} and the sentence vector S_{emb} ∈S_{emb};
(3) retrieving a target sentence set Sᵣₑₗ={s|sim(s, m)>f, s∈Sₑ} whose semantic similarity is greater than a threshold f, i.e., constructing the target sentence set according to sentences corresponding to semantic similarities greater than the semantic similarity threshold f; and
(4) extracting relevant entity information m from the target sentence set Sᵣₑₗ by using the LLMs.

The following uses retrieval-augmented generation for a question “What age was a person when he published ResNet” as an example to specifically explain the graph enhanced retrieval method provided in this embodiment.

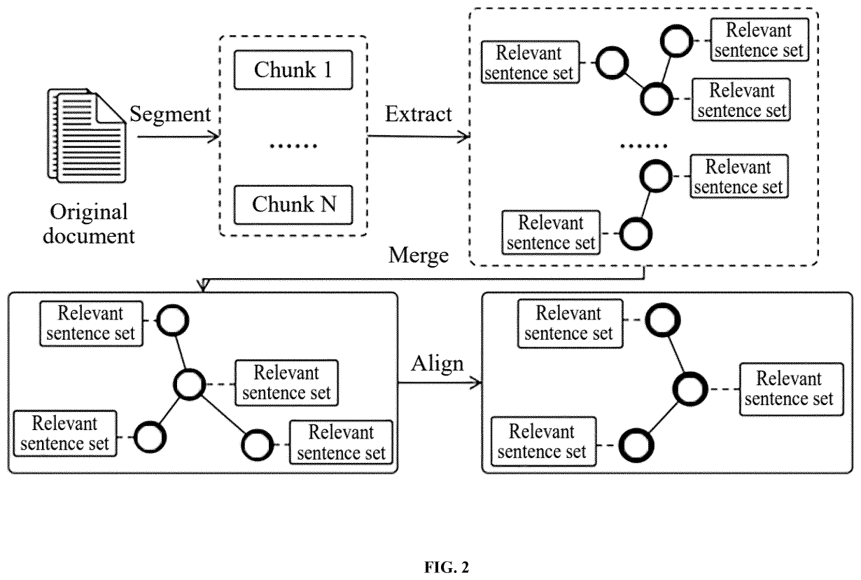

Before retrieval-augmented generation is performed, it is necessary to first construct a semantic-enhanced knowledge graph on a number of documents provided by a user. A method flow thereof is shown in FIG. 2.

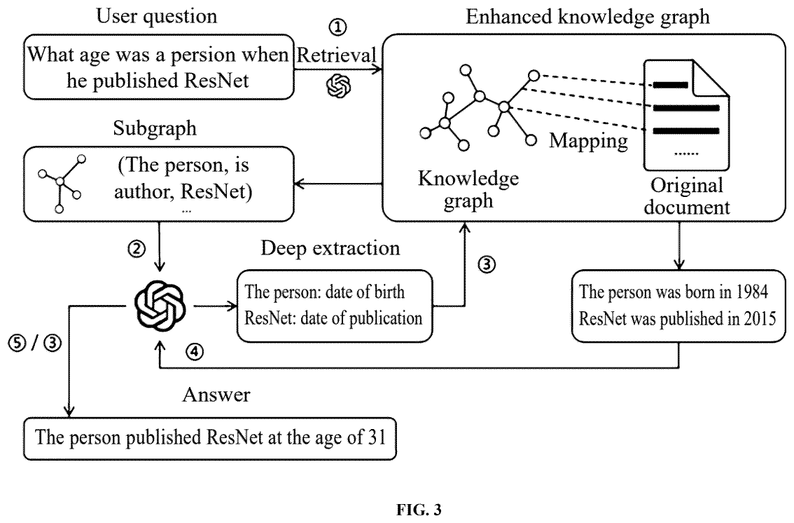

As shown in FIG. 3, this embodiment provides a specific example of a graph enhanced retrieval method, including steps 1-8.

In step 1, sentence segmentation is performed on a document T by using an “en_core_web_sm” language model and a “cl100k_base” model is used as a tokenization model to calculate the number of tokens of each sentence. When a text is segmented, a chunk size is set to cs, and consecutive sentences whose total number of tokens does not exceed cs are grouped into a chunk to obtain

$$T = \{ {chunk}_{p} = \{ {s}_{i} , {s}_{i + 1} , … , {s}_{j} \} \vert {\sum }_{t = i}^{j} Token ( {s}_{t} ) \leq k , 1 \leq i \leq j \leq n \} .$$

In step 2, for each chunk chunkᵢ∈T, a “gpt-4o-mini” is prompted to extract entity information of a specified entity type, including an entity name, an entity type, and an entity description. A specific prompt for entity extraction is “Given a text document and an entity type list, identify all entities. For each identified entity, extract the following information: \n-Entity name: Name of an entity in the text\n-Entity type: one of the following types: {Entity type}\n-Entity description: Full description of the entity \n \n Text: \n {Input text} \n Output: “. After entity information extraction, the “gpt-4o-min” is further prompted to extract relations between the extracted entities. A prompt for relation extraction is: “Given a text document and an entity list, identify all pairs (source entity, target entity) that are explicitly relevant to each other. For each pair of relevant entities, extract the following information: \n-Source entity\n-Target entity\n-Relationship description: Description of a relationship between the source entity and target entity\n-Reference: Sentences in the text that can prove this relation\n\nEntity: \n {Entity} \n Text: \{Input text}\nOutput: “. An output result of the model is parsed to obtain εᵢ={e₁, e₂, . . . , eₙ} and vᵢ={rₖ=(eₚ, e_{q})}. The “gpt-4o-mini” model is prompted to evaluate an information quantity of the sentence in chunkᵢ. A prompt for evaluation is: “Your task is to score each text based on its information content in the given list, with texts including more detailed information being scored higher. Scores range from 0 to 10, inclusive. Return \n text in JSON format: \n{input_text}\nOutput: “. For a sentence s whose score is greater than or equal to a threshold p, if entity e∈εᵢ is present in s, then s is mapped to e; if entity s is a support for a relation between entities eₚ ∈εᵢ and e_{q}∈εᵢ, then s is mapped to rₖ=(eₚ, e_{q})∈vᵢ to obtain mapping relations between the sentence set and the entity set Sᵢ and the relationship set Mi, thus constructing a semantic-enhanced knowledge graph EGᵢ on chunkᵢ. EGᵢ are merged to obtain a semantic-enhanced knowledge graph EG on T.

In step 3, for entity node set ε of EG, pre-categorization is performed according to entity types, and cosine similarity is calculated between entities of the same type by using a “text-embedding-3-small” model as an embedding model and vectorizing “<entity name>: <entity description>” as a vector representation of the entity. For n-dimensional vectors a, b, a cosine similarity calculation formula is as follows:

$$s i m ( a ( {a}_{1} , {a}_{2} , … , {a}_{n} ) , b ( {b}_{1} , {b}_{2} , … , {b}_{n} ) ) = \frac{{\sum }_{i = 1}^{n} {a}_{i} {b}_{i}}{\sqrt{{\sum }_{i = 1}^{n} {a}_{i}^{2}} \sqrt{{\sum }_{i = 1}^{n} {b}_{i}^{2}}} ,$$

where a, b represent the n-dimensional vectors, and aᵢ, bᵢ respectively represent data for each dimension of the vectors a, b.

An association edge is added to entities whose similarity is higher than a threshold f to construct an inter-entity association graph g=(ε, v), where v={(eᵢ, eⱼ)|sim(eᵢ, eⱼ)>f}. The “gpt-4o-mini” model is prompted to determine the same entity in a set of entity nodes of all connected subgraphs in the relation graph g. A prompt for determining is “Group, according to the entity description, all entities in the given list that refer to the same real-world entity into a group. \ nEntity list: \n {Entity} \nOutput: “. The same entities in the semantic-enhanced knowledge graph EG are merged.

In step 4, for the question q “What age was a person when he published ResNet?”, the “gpt-4o-mini” model is prompted to extract all explicit entities ε_{q}. A prompt for extracting the entities is “Extract entities from the given text and return them as a JSON list, as shown below: In Text: \n {Input text} \nOutput: “. Entities” a person” and “ResNet” are extracted.

In step 5, subgraph expansion is performed on the basis of the explicit entity set ε_{q} extracted in step 4. The entity list E is maintained, and entities in the explicit entity set ε_{q} are added to the entity list E. For an entity in the entity list E, neighbor nodes thereof in the semantic-enhanced knowledge graph EG are traversed, to vectorize the user question q and relationship r between the entities and the neighbors thereof by using a “text-embedding-3-small” model as an embedding model to obtain q_{emb} and r_{emb}, respectively. A cosine similarity between q_{emb} and r_{emb} is calculated, and if the similarity is greater than a threshold f, the neighbors are added to the entity list E. This process is repeated until all entities in the entity list E have been visited. In this way, an entity set εₛ={e₁, e₂, . . . , eₘ} including explicit entities and implicit entities is obtained. A subgraph EG_{sub} is extracted from the semantic-enhanced knowledge graph EG according to the entity set εₛ.

In step 6, “gpt-4o-mini” is prompted to determine whether the entity and relationship information provided in the subgraph EG_{sub} can answer the user question q. A prompt for determining is “Please determine whether the given knowledge graph can support answering the question. If yes, output “yes”; otherwise, output “No”. In Standard: The knowledge graph must include all information required to fully answer the question. In Knowledge graph: \n{Knowledge Graph}\n Question: \n {Question}\n Output: “. If the subgraph can answer the user question, the entity and relationship information are used as a context, and the context is assembled with the user question q together as a prompt, so that the “gpt-4o-mini” finally responds r.

In step 7, the “gpt-4o-mini” is prompted to determine what entity information is required in addition to the entity and relationship information provided in step 6. A prompt for determining is “What specific entity information is required to answer this question? \n Output: “. An output of the model is parsed, showing that an information “date of birth” of the entity “a person” and an information “date of publication” of the entity “ResNet” are required. Sentences relevant to specific information are retrieved from a sentence set Sₑ={s|(e, s)∈M} relevant to entity e. The text is vectorized and the required entity information m and each sentence in the sentence set Sₑ are separately vectorized by using “text-embedding-3-small” as an embedding model. A cosine similarity between m and each sentence in the sentence set Sₑ is calculated, and sentences whose similarity is greater than a threshold fare retrieved. The “gpt-4o-mini” is prompted to extract the specific information from the retrieved sentences. A prompt for extraction is “Extract information about the entity according to the provided context, and output only the extracted information. \nEntity: {Entity} \nInformation: {Properties} \nContext: \n {Context} InOutput: “. The specific information “Date of Birth” of the entity “a person” is extracted as “a person was born in 1984”, and the specific information “Date of Publication” of the entity “ResNet” is extracted as “ResNet was published in 2015”.

In step 8, the entity and relation information provided in step 6 with the entity-specific information extracted in step 7 are combined as a context, and the context is assembled with the user question q together into a prompt, so that “gpt-4o-mini” finally responds r.

This embodiment relates to a retrieval-augmented generation method. Firstly, rich structured relation information and semantic information are extracted from an original document by using LLMs, and a semantic-enhanced knowledge graph is constructed; then, an efficient retrieval-augmented generation method is proposed based on the semantic-enhanced knowledge graph to answer a user question. The method includes:
1) performing text segmentation on an original text document, performing information extraction by using the LLMs, and constructing a semantic-enhanced knowledge graph; and
2) based on the semantic-enhanced knowledge graph, providing an efficient retrieval-augmented generation method, including: extracting explicit entities according to a user question, retrieving implicit entities on the semantic-enhanced knowledge graph, extracting relevant entity information from the semantic-enhanced knowledge graph by using the LLMs, and then returning an answer by assembling prompts and calling the large model.

Compared with traditional knowledge graphs, the foregoing retrieval-augmented generation method provided in this embodiment can provide richer structured relation information and semantic information (the relation between the knowledge graph and the original document is constructed, enhancing detail information of the entities and semantic information of the knowledge graph), effectively improving the accuracy of question answering. A deep extraction scheme is proposed to extract specific information required for a specific entity as needed, rather than extracting specified entity information during construction of the knowledge graph, so that the method of this embodiment is universal.

### Embodiment 2

This embodiment provides a retrieval-augmented generation apparatus based on a semantic-enhanced knowledge graph, including a document obtaining module, a semantic-enhanced knowledge graph construction module, an entity alignment and merging module, an explicit entity extraction module, a subgraph expansion module, a subgraph construction module, and a determination module.

The document obtaining module is configured to obtain an original text document.

The semantic-enhanced knowledge graph construction module is configured to construct a semantic-enhanced knowledge graph according to entity information and inter-entity relational information extracted from the original text document. The semantic-enhanced knowledge graph includes an entity set, an inter-entity relationship set, a relevant sentence set, and a mapping relation set. The relevant sentence set refers to a set of sentences relevant to entities and inter-entity relationships, and the mapping relation set refers to a set of mapping relations between sentences in the original text document and target objects. The target objects are entity nodes and relationship edges in the knowledge graph.

The subgraph construction module is configured to obtain a subgraph according to an explicit entity set and the semantic-enhanced knowledge graph.

The determination module is configured to determine, by using LLMs, whether entity information and inter-entity relational information in the subgraph are sufficient to answer a user question, to obtain a first determination result. If the first determination result is yes, the entity information and the inter-entity relational information in the subgraph are used as a first context, and a first prompt is constructed according to the first context and the user question; and based on the first prompt by using the LLMs, an answer corresponding to the user question is generated. If the first determination result is no, relevant entity information is extracted from a hybrid relevant sentence set, the relevant entity information and the entity information and the inter-entity relational information in the subgraph are used as a second context, and a second prompt is constructed according to the second context and the user question; and based on the second prompt by using the LLMs, an answer corresponding to the user question are generated. The hybrid relevant sentence set is a set of sentences in the subgraph relevant to hybrid entities and inter-hybrid entity relationships.

The technical features of the above embodiments may be combined arbitrarily. To make the description concise, not all possible combinations of the technical features in the above embodiments are described. However, these combinations should be considered to be within the scope of the description of the present disclosure as long as there is no contradiction in the combinations of these technical features.

The principle and embodiments of the disclosure are described herein by using specific examples, the above descriptions of the embodiments are merely intended to help understand the methods and core idea of the disclosure. In addition, for those of ordinary skill in the art, changes may be made to the specific embodiments and the scope of disclosure according to the concept of the disclosure. In summary, the content of the description should not be construed as a limitation to the disclosure.

What is claimed is:

1. A retrieval-augmented generation method based on a semantic-enhanced knowledge graph, comprising:
acquiring an original text document;
constructing a semantic-enhanced knowledge graph according to entity information and inter-entity relational information extracted from the original text document, wherein the semantic-enhanced knowledge graph comprises an entity set, an inter-entity relationship set, a relevant sentence set, and a mapping relation set, wherein the relevant sentence set refers to a set of sentences relevant to entities and inter-entity relationships, and the mapping relation set refers to a set of mapping relations between sentences in the original text document and target objects, wherein the target objects are entity nodes and relationship edges in the semantic-enhanced knowledge graph;
obtaining a subgraph according to an explicit entity set and the semantic-enhanced knowledge graph; and
determining, by using large language models (LLMs), whether entity information and inter-entity relational information in the subgraph are sufficient to answer a user question, to obtain a first determination result:
in responding to the first determination result indicating that the entity information and the inter-entity relational information in the subgraph are sufficient to answer the user question, using the entity information and the inter-entity relational information in the subgraph as a first context, and constructing a first prompt according to the first context and the user question; and generating, based on the first prompt by using the LLMs, an answer corresponding to the user question; and
in responding to the first determination result indicating that the entity information and the inter-entity relational information in the subgraph are not sufficient to answer the user question, extracting relevant entity information from a hybrid relevant sentence set, using the relevant entity information and the entity information and the inter-entity relational information in the subgraph as a second context, and constructing a second prompt according to the second context and the user question, wherein the hybrid relevant sentence set is a set of sentences in the subgraph relevant to hybrid entities and inter-hybrid entity relationships; and generating, based on the second prompt by using the LLMs, an answer corresponding to the user question.

2. The retrieval-augmented generation method based on the semantic-enhanced knowledge graph according to claim 1, wherein a process of extracting the entity information and the inter-entity relational information from the original text document comprises:
performing document segmentation on the original text document to obtain a chunk set comprising a number of chunks;
performing sentence segmentation on the original text document by using a language model to obtain a sentence set comprising a number of sentences;
calculating a number of tokens of each sentence in the sentence set by using a tokenization model;
grouping consecutive sentences whose total number of tokens does not exceed a predetermined chunk size into a chunk;
constructing a chunk set according to all the chunks; and
extracting the entity information and the inter-entity relational information from the chunk set.

3. The retrieval-augmented generation method based on the semantic-enhanced knowledge graph according to claim 2, wherein the constructing a semantic-enhanced knowledge graph according to entity information and inter-entity relational information extracted from the original text document comprises:
constructing a chunk semantic-enhanced knowledge graph according to each chunk in the chunk set; and
merging all chunk semantic-enhanced knowledge graphs to obtain the semantic-enhanced knowledge graph of the original text document, wherein
the constructing a chunk semantic-enhanced knowledge graph according to each chunk in the chunk set comprises:
extracting entity information and inter-entity relational information of a specified entity type from each chunk by using the LLMs, wherein the entity information comprises an entity name, an entity type, and an entity description, and the inter-entity relational information comprises a source entity, a target entity, a relationship description, and a relation basis;
constructing a chunk entity set and a chunk inter-entity relationship set according to the extracted entity information and inter-entity relational information of the specified entity type, wherein the chunk inter-entity relationship set comprises relations among a number of entities in the chunk entity set;
evaluating an information content score of sentences in each chunk by using the LLMs;
establishing, when the information content score is not less than an information content threshold and entities present in the sentences belong to the chunk entity set, mapping relations between the sentences and the entities present in the sentences;
constructing, according to the mapping relations between the sentences and the entities present in the sentences, a mapping relation set between chunk text contents and the entities;
establishing, when the information content score is not less than the information content threshold and the sentences are derived from inter-entity relationships in the chunk inter-entity relationship set, mapping relations between the sentences and the inter-entity relationships in the chunk inter-entity relationship set;
constructing, according to the mapping relations between the sentences and the inter-entity relationships in the chunk inter-entity relationship set, a mapping relation set between the chunk text contents and the inter-entity relationships;
determining a chunk mapping relation set and a chunk relevant sentence set according to the mapping relation set between the chunk text contents and the entities and the mapping relation set between the chunk text contents and the inter-entity relationships; and
constructing the chunk semantic-enhanced knowledge graph according to the chunk entity set, the chunk inter-entity relationship set, the chunk relevant sentence set, and the chunk mapping relation set.

4. The retrieval-augmented generation method based on the semantic-enhanced knowledge graph according to claim 3, wherein the obtaining a subgraph according to an explicit entity set and the semantic-enhanced knowledge graph comprises:
performing entity alignment on the semantic-enhanced knowledge graph to obtain an aligned semantic-enhanced knowledge graph;
extracting, by using the LLMs, entities present in the user question, to obtain the explicit entity set comprising a number of explicit entities;
performing subgraph expansion on the aligned semantic-enhanced knowledge graph according to the explicit entity set, to obtain a hybrid entity set comprising the explicit entities and implicit entities, wherein the implicit entities refer to entities involved with the user question but not present in the user question;
extracting the subgraph from the semantic-enhanced knowledge graph according to the hybrid entity set.

5. The retrieval-augmented generation method based on the semantic-enhanced knowledge graph according to claim 4, wherein the performing entity alignment on the semantic-enhanced knowledge graph to obtain an aligned semantic-enhanced knowledge graph comprises:
pre-categorizing the entities according to the entity type to obtain an entity type set comprising a number of entities of different types;
performing clustering on entities of same type in the entity type set based on semantic similarity, to obtain a clustered entity set;
determining, by using the LLMs, whether entities in the clustered entity set are the same entity, to obtain a second determination result; and
merging, in responding to the second determination result indicating that the entities in the clustered entity set are the same entity, entity nodes belonging to the same entity in the semantic-enhanced knowledge graph.

6. The retrieval-augmented generation method based on the semantic-enhanced knowledge graph according to claim 4, wherein the performing subgraph expansion on the aligned semantic-enhanced knowledge graph according to the explicit entity set, to obtain a hybrid entity set comprising the explicit entities and implicit entities comprises:
adding the explicit entities in the explicit entity set to an initial entity list;
performing text vectorization on the user question by using an embedding model, to obtain a question vector;
traversing, for each explicit entity in the initial list, the semantic-enhanced knowledge graph to determine neighbor nodes;
performing text vectorization on a neighbor relationship description by using the embedding model, to obtain a neighbor relationship description vector, wherein the neighbor relationship description refers to a description of a relationship between a neighbor node not in the initial entity list and a corresponding explicit entity;
calculating a first similarity between the question vector and the neighbor relationship description vector;
adding, in a case of the first similarity being greater than a first similarity threshold, the corresponding neighbor node to the initial entity list to obtain an updated entity list;
using the updated entity list as a new initial entity list, returning to the traversing, for each explicit entity in the initial list, the semantic-enhanced knowledge graph to determine neighbor nodes, to obtain a final entity list; and
obtaining, according to the final entity list, the hybrid entity set comprising the explicit entities and the implicit entities.

7. The retrieval-augmented generation method based on the semantic-enhanced knowledge graph according to claim 1, wherein the extracting relevant entity information from a hybrid relevant sentence set comprises:
performing text vectorization on required entity information and each sentence in the hybrid relevant sentence set by using an embedding model, to obtain a required entity information vector and a sentence vector, wherein the required entity information refers to entity information in the subgraph for which the first determination result indicating that the entity information and the inter-entity relational information in the subgraph are not sufficient to answer the user question;
calculating a semantic similarity between the required entity vector and the sentence vector;
constructing a target sentence set according to sentences whose semantic similarity is greater than a semantic similarity threshold; and
extracting the relevant entity information from the target sentence set by using the LLMs.

8. The retrieval-augmented generation method based on the semantic-enhanced knowledge graph according to claim 5, wherein the performing clustering on entities of same type in the entity type set based on semantic similarity, to obtain a clustered entity set comprises:
performing, by using the embedding model, text vectorization on entity names and corresponding entity descriptions of the entities of the same type in the entity type set, to obtain each entity vector;
calculating a second similarity according to the entity vector;
adding association edges to entities whose second similarity is higher than a second similarity threshold, to construct an inter-entity association graph;
extracting all connected subgraphs in the inter-entity association graph; and
constructing the clustered entity set according to nodes comprised in the connected subgraphs.

9. A retrieval-augmented generation apparatus based on a semantic-enhanced knowledge graph, comprising:
a document obtaining module, configured to obtain an original text document;
a semantic-enhanced knowledge graph construction module, configured to construct a semantic-enhanced knowledge graph according to entity information and inter-entity relational information extracted from the original text document, wherein the semantic-enhanced knowledge graph comprises an entity set, an inter-entity relationship set, a relevant sentence set, and a mapping relation set, wherein the relevant sentence set refers to a set of sentences relevant to entities and inter-entity relationships, and the mapping relation set refers to a set of mapping relations between sentences in the original text document and target objects, wherein the target objects are entity nodes and relationship edges in the semantic-enhanced knowledge graph;
a subgraph construction module, configured to obtain a subgraph according to an explicit entity set and the semantic-enhanced knowledge graph; and
a determination module, configured to: determine, by using large language models (LLMs), whether entity information and inter-entity relational information in the subgraph are sufficient to answer a user question, to obtain a first determination result: in responding to the first determination result indicating that entity information and the inter-entity relational information in the subgraph are sufficient to answer the user question, use the entity information and the inter-entity relational information in the subgraph as a first context, and construct a first prompt according to the first context and the user question; and generate, based on the first prompt by using the LLMs, an answer corresponding to the user question; and in responding to the first determination result indicating that the entity information and the inter-entity relational information in the subgraph are not sufficient to answer the user question, extract relevant entity information from a hybrid relevant sentence set, use the relevant entity information and the entity information and the inter-entity relational information in the subgraph as a second context, and construct a second prompt according to the second context and the user question; and generate, based on the second prompt by using the LLMs, an answer corresponding to the user question, wherein the hybrid relevant sentence set is a set of sentences in the subgraph relevant to hybrid entities and inter-hybrid entity relationships.
